(19) United States
(12) Patent Application Publication
(10) Pub. No.: US 2026/0220628 A1
(43) Pub. Date: Jul. 30, 2026

(54) SYNTHETIC BIOMETRIC CREDENTIAL

(71) Applicant: International Business Machines Corporation, Armonk, NY (US)

(72) Inventors: Sumabala NAIR, Austin, TX (US); Naga ManojKasyap CHILAKAMARTHY VENKATA, Austin, TX (US); Abhijit THAKUR, Austin, TX (US)

(21) Appl. No.: 19/040,382

(22) Filed: Jan. 29, 2025

(51) Int. Cl. G06Q 20/36; G06Q 20/38; G06Q 20/40

(52) U.S. Cl. CPC G06Q 20/3674; G06Q 20/3829; G06Q 20/40145

(57) ABSTRACT

In some implementations, a device may receive a request for verification of an identity. The device may transmit, in response to the request, a synthetic biometric credential stored in a digital wallet, wherein the synthetic biometric credential is a private-key encrypted or hashed representation of a biometric template associated with the identity.

### BACKGROUND

This disclosure relates to biometrics, and more specifically, to using biometrics for identification.

### SUMMARY

Some implementations described herein relate to a computer-implemented method. The computer-implemented method includes receiving, by a processor set, a request for verification of an identity. The computer-implemented method includes transmitting, by the processor set in response to the request, a synthetic biometric credential stored in a digital wallet, where the synthetic biometric credential is a private-key encrypted or hashed representation of a biometric template associated with the identity.

Some implementations described herein relate to a computer system. The computer system may include a processor set, one or more computer-readable storage media, and program instructions stored on the one or more computer-readable storage media to cause the processor set to perform operations. The operations may comprise collecting a biometric template associated with an identity. The operations may comprise generating a synthetic biometric credential by encrypting or hashing the biometric template using an encryption algorithm and a seed. The operations may comprise issuing the synthetic biometric credential. The operations may comprise storing metadata associated with the synthetic biometric credential. The operations may comprise publishing a public key in a verifiable data registry.

Some implementations described herein relate to a computer program product that includes one or more computer-readable storage media and program instructions stored on the one or more computer-readable storage media to perform operations. The operations may comprise receiving a synthetic biometric credential that is a digital representation of a biometric template associated with an identity. The operations may comprise obtaining a public key from a verifiable data registry. The operations may comprise verifying an authenticity of the synthetic biometric credential using the public key. The operations may comprise transmitting a verification based on the authenticity of the synthetic biometric credential.

### BRIEF DESCRIPTION OF THE DRAWINGS

FIG. 1 is a diagram of an example computing environment for data extraction using synthetic biometric credentials described herein.

FIG. 2 illustrates different types of biometric markers that can be used for generating synthetic biometric credentials.

FIG. 3 depicts a diagram of a process for generating and verifying synthetic biometric credentials.

FIG. 4 is a flowchart of an example process associated with synthetic biometric credentials.

FIG. 5 is a flowchart of an example process associated with synthetic biometric credentials.

FIG. 6 is a flowchart of an example process associated with synthetic biometric credentials.

### DETAILED DESCRIPTION

The following detailed description of example implementations refers to the accompanying drawings. The same reference numbers in different drawings may identify the same or similar elements.

Biometric authentication of a person has become increasingly prevalent in various sectors, including government, finance, and healthcare. However, the current methods of collecting, storing, and verifying biometric data pose significant risks to the privacy and security of the person (holder) to which the biometric template belongs. Biometric templates, which are unique digital representations of the holder's biometric characteristics, are often stored centrally and can be vulnerable to hacking and unauthorized access. Furthermore, the use of physical devices to scan biometrics can be prone to errors and bias.

The widespread adoption of biometric authentication has also raised concerns about the potential for mass surveillance, data breaches, and identity theft. Individuals have limited control over their biometric data and may not be aware of how the biometric data is being used, shared, or stored. The lack of standardized regulations and governance frameworks for biometric data handling exacerbates these risks.

In addition, the use of biometric authentication can be intrusive and inconvenient, requiring individuals to undergo repeated scans and verifications. This can lead to a poor user experience and create barriers to access for certain individuals. Moreover, the current biometric authentication systems are often not designed to accommodate changes in an individual's biometric characteristics over time, which can lead to false negatives or failed authentications. Other issues include biometric spoofing and template reversibility.

Some implementations described herein provide a computing system for secure biometric authentication. For example, a trusted issuer may obtain a biometric template of the holder and transform the biometric template into a synthetic biometric credential. The issuer may issue the synthetic biometric credential to the holder. The holder may later seek secure access at an in-person event or via a mobile application. The holder may receive a request for verification of the identity of the holder. The holder may present the synthetic biometric credential stored in a digital wallet of a holder device, where the synthetic biometric credential is a private-key encrypted or hashed representation of a biometric template associated with the identity. The holder may select what amount of the biometric template credential to provide to the verifier. The verifier may use a public key from a data registry and the synthetic biometric credential to verify the identity of the holder without obtaining raw biometric data from the holder.

In this way, the synthetic biometric credential provides secure biometric authentication while minimizing exposure of sensitive biometric data. The use of synthetic biometric credentials reduces the computational overhead associated with storing and transmitting raw biometric data, thereby conserving processing resources, memory resources, and network resources. Additionally, the use of public-key encryption and verifiable data registries for the synthetic biometric credential ensures the authenticity and integrity of the synthetic biometric credentials, thereby reducing the risk of data breaches and identity theft. By minimizing the amount of sensitive data in transit and in storage, the synthetic biometric credential also reduces the attack vectors and mitigates the risk of unauthorized access. In this way, the use of the synthetic biometric credential conserves processing resources, memory resources, network resources, and/or the like.

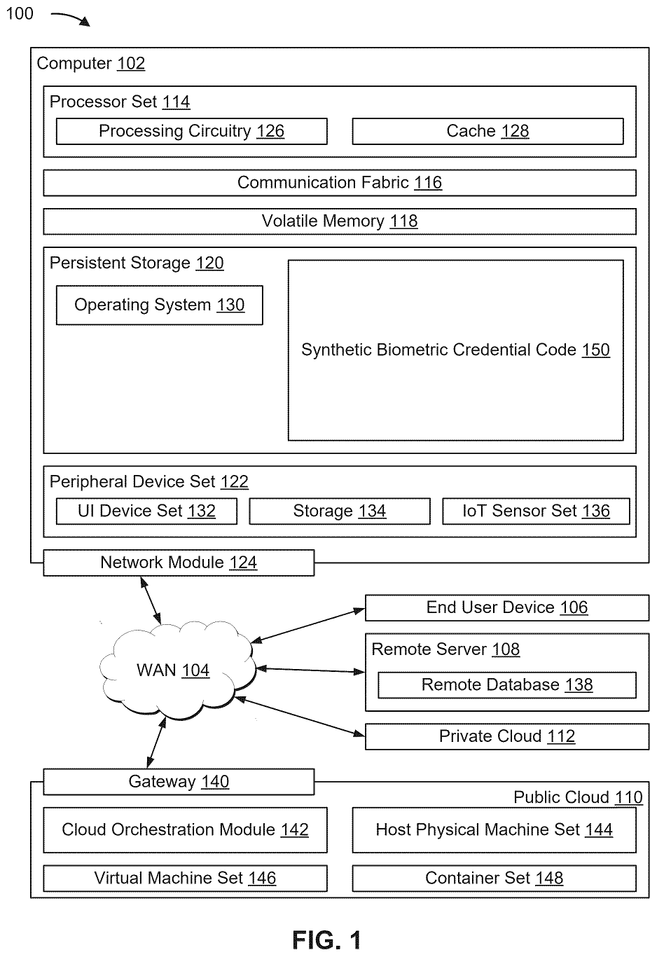

FIG. 1 is a diagram of an example computing environment 100 for synthetic biometric credentials described herein.

Computing environment 100 contains an example of an environment for the execution of at least some of the computer code involved in performing the inventive methods, such as synthetic biometric credential evaluation code 150. In addition to synthetic biometric credential code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and synthetic biometric credential code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in synthetic biometric credential code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

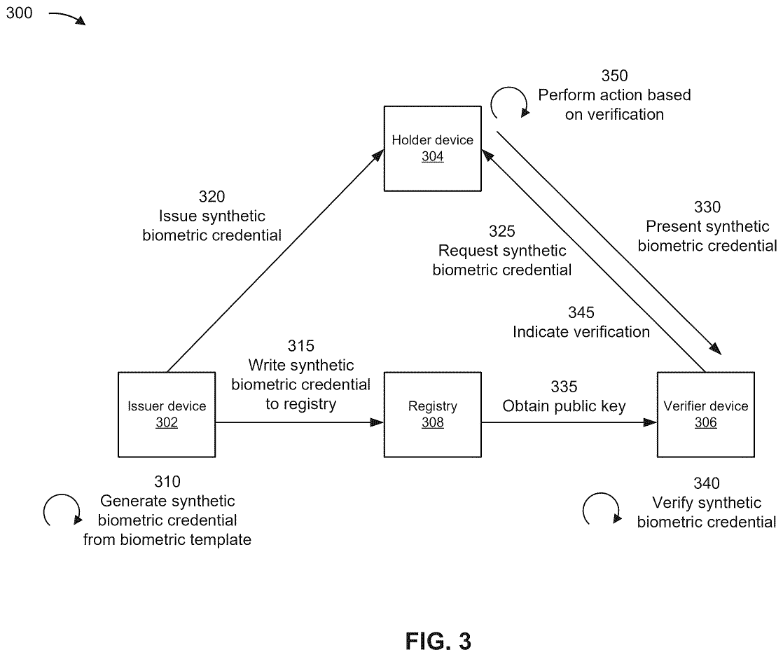

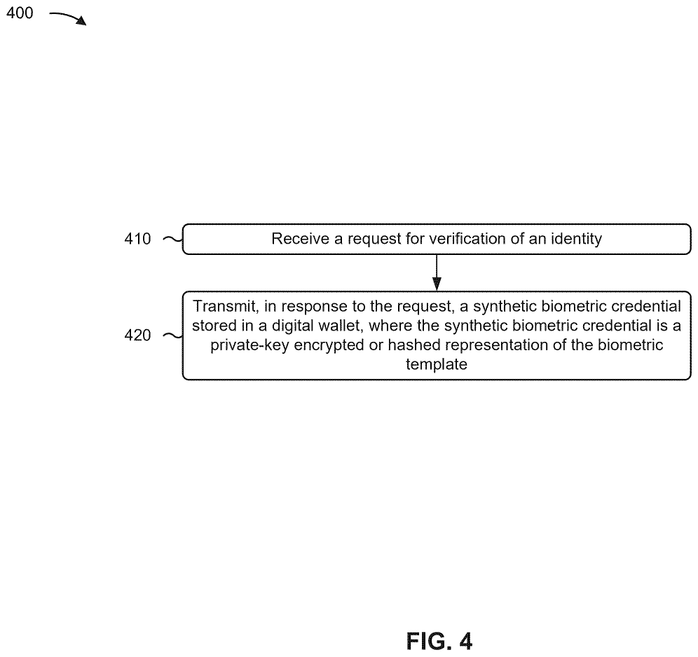

The code included in the synthetic biometric credential code 150 typically includes at least some of the computer code involved in performing one or more operations described herein, such as the operations of diagram 300 in FIG. 3 and the processes described in FIGS. 4-6.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

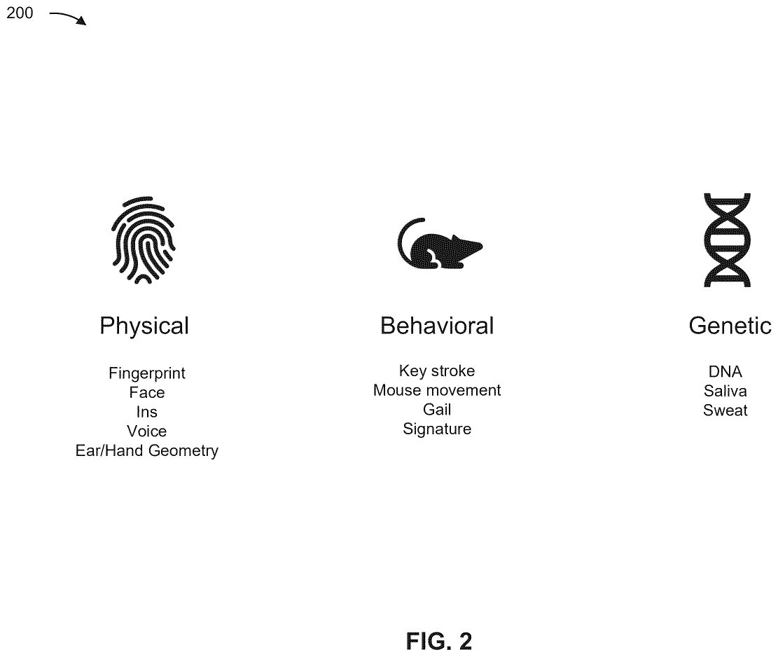

FIG. 2 illustrates different types of biometric markers 200 that can be used for generating synthetic biometric credentials. These include physical biometric markers such as fingerprints, faces, iris scans, a voice, and ear/hand geometry, as well as behavioral biometric markers such as keystroke patterns, mouse movements, a gait, and signatures. Additionally, genetic biometric markers may include DNA, saliva, and sweat.

FIG. 3 depicts a diagram 300 of a process for generating and verifying synthetic biometric credentials.

A synthetic biometric credential may be issued to an individual (holder of the identity associated with the biometric template) by a trusted issuer (trusted governmental or certified agency). The issuer (using issuer device 302) may collect raw biometric data from the holder, such as a fingerprint, a face scan, or an iris scan. The issuer device 302 may generate a verifiable credential, such as a synthetic biometric credential (template or claim), from the collected biometric data (operation 310). The synthetic biometric credential may be a unique digital representation of the holder's biometric characteristics. For example, the issuer device 302 may transform the biometric template into the synthetic equivalent using a seed and an encryption algorithm. The seed used in the transformation process may be a random value that is used to initialize the encryption algorithm. The encryption algorithm may be a standard encryption algorithm, such as an Advanced Encryption Standard (AES) algorithm or a Rivist-Shamir-Adleman (RSA) algorithm. In some implementations, the issuer device 302 may create the synthetic biometric credential using hashing. The biometric template may be hashed using a one-way hash function to produce a fixed-size string of characters. The synthetic biometric marker may be designed to protect the holder's personal biometric data during identity verification and prevent unauthorized access that may occur when providing raw biometric data to an untrustworthy verifier or a verifier with sub-optimal security.

In an example, the issuer device 302 may collect a fingerprint (biometric template) from the holder to create a synthetic biometric template from the fingerprint. The synthetic biometric template is a unique digital representation of the holder's fingerprint. The holder device 304 may request the synthetic biometric credential from the issuer device 302. This request may be made in person or through a secure channel, such as a secure website or a secure mobile application. The holder may be required to provide identification or authentication to access the synthetic biometric credential.

The issuer device 302 may use a seed value to initialize the encryption algorithm (e.g., used in AES-256). Alternatively, in some implementations, the biometric template may be hashed using a one-way hash function, such as Secure Hash Algorithm (SHA)-256, to produce a fixed-size string of characters. The hashed biometric template may also be encrypted using the AES-256 encryption algorithm and the seed value.

The encrypted and/or hashed biometric template is then encoded into a synthetic biometric credential. The issuer device 302 may extract synthetic biometric features from the synthetic biometric template (or from transformed data.) The features may be used to create the synthetic biometric credential as a unique and compact representation of the holder's biometric data. The resulting synthetic biometric credential is a digital representation of the holder's fingerprint that can be used for authentication and verification purposes, while preventing unauthorized access.

The issuer device 302 may sign the synthetic biometric credential with a private key (both the holder device 304 and the issuer device 302 may sign the synthetic biometric credential). The issuer device 302 may then issue the synthetic biometric credential to the holder (holder device 304) (operation 320 in FIG. 3). A digital wallet of the holder device 304 may provide credentials to the issuer device 302 for verification, which may include extraction of an identifier (ID) and an encrypted date, retrieval of the decryption mechanism and keys (using the ID), decryption of the credentials, and comparison of biometrics. The issuer device 302 may have created the synthetic biometric credential further based on the ID. Upon verification of the digital wallet, the issuer device 302 may provide the synthetic biometric credential to the holder device 304, which may store the synthetic biometric credential securely in the digital wallet.

The issuer device 302 may select a decentralized identifier (DID) method and publish the DID document in a data registry 308 with a public key (operation 315). Other attributes may be stored as per verifiable credential principles. The issuer device 302 may generate and securely store (e.g., in a database) metadata for the synthetic biometric credential. The metadata may be a minimum amount of metadata for life cycle management and may include an ID, a transpose key information for decryption, status lists, and/or entry positions. Status lists may be stored in the verifiable data registry so that verifiers can access the status lists. The location of a status list and an index of the synthetic biometric credential on the status list may also be part of the metadata.

The synthetic biometric credential may be stored at the holder device 304 in a digital wallet, via a smart card or a device memory, and used for authentication and verification purposes. When the holder wants to access a secure system or resource (e.g., financial service, gaming experience, entertainment venue, travel and hospitality experience, retail experience, health application, perimeter entry, government building entry, access to service, access to workplace or enterprise, access to a special event, access to wearable), the holder may use the holder device 304 to present the synthetic biometric credential to a verifier (verifier device 306), to be verified to confirm the identity of the holder. The digital wallet of the holder device 304 may provide a signed and verifiable presentation. The verifier device 306 may retrieve the public key of the issuer device 302 from the registry 308 and verify the synthetic biometric credential. The verifier device 306 may retrieve the public keys of both the holder and the issuer and verify the signatures of the holder and the issuer. The verifier device 306 may also check a credential status of the synthetic biometric credential.

If the holder is to authenticate its identity for a verifier device 306, the verifier device 306 may request presentation of the synthetic biometric credential from the holder device 304 (operation 325). The holder device 304 may decrypt the presentation request using the private key and verify the authenticity of the request. The holder device 304 may present (e.g., transmit) the synthetic biometric credential to the verifier device 306 (operation 330), which obtains (e.g., reads) a public key from the registry (operation 335) and verifies the synthetic biometric credential using the public key (operation 340). In some implementations, presentation of the synthetic biometric credential may include obtaining and processing a quick response (QR) code or exchanging NFC signals or Bluetooth low energy (BLE) signals. Biometric data may be combined with other credentials in a single presentation.

The verifier device 306 may compare the synthetic biometric credential (and any other metadata from the holder device 304) and the public key, for verification. This involves decrypting the synthetic biometric credential and checking its authenticity. In some implementations, the verifier can use a combination of cryptographic and biometric verification techniques to verify the authenticity of the synthetic biometric credential. The verifier device 306 may indicate a verification of the identity to the holder device 304, if verification is successful (operation 345). The verifier device 306 may also indicate an unsuccessful verification.

If the verification is successful, the holder device 304 may perform an action based on the verification (operation 350). This may include gaining secure access digitally or in person. The verification of the synthetic biometric marker is a secure and efficient way to authenticate a holder's identity. The synthetic biometric credential eliminates the need for physical biometric data to be stored or transmitted, reducing the risk of unauthorized access and protecting the holder's biometric data. The use of public and private keys establishes trust between the verifier and the holder, as the verifier can trust that the holder's identity has been verified. The use of public and private keys enables the verification process to be scalable and efficient, as multiple verifiers can use the same public key to verify the holder's identity.

In some implementations, the issuer device 302 may collect multiple biometrics (e.g., a face, a voice, a movement, a keystroke, a fingerprint) and encrypt these individual biometric attributes or claims. Encrypted attributes may be combined into a superset of biometric attributes or split across multiple synthetic biometric credentials. The holder device 304 may selectively disclose one or more of the multiple synthetic biometric credentials. For example, the verifier device 306 may request presentation of facial landmarks and the first three contours of fingerprints. The holder device 304 may select and disclose synthetic biometric markers only for the requested biometric attributes. The synthetic biometric credentials may be provided in combination with other credentials (e.g., education, driver's license) in a presentation.

In some implementations, the issuer device 302 may help to manage a life cycle of the synthetic biometric credential. The issuer device 302 may use a combination of manual and automated systems to manage the life cycle. For example, the holder device 304 or the verifier device 306 may request that the issuer device 302 suspend, revoke, or reissue the synthetic biometric credential as needed, and the status of the synthetic biometric credential may be updated in the registry 308. In other examples, a holder may suspect that a synthetic biometric credential is compromised, or the verifier device 306 may detect a fraudulent identity. The holder device 304 or the verifier device 306 may request that the issuer device 302 suspend or revoke the synthetic biometric credential. The issuer device 302 may also suspend the synthetic biometric credential if the issuer device 302 suspects that the synthetic biometric device is compromised for other reasons (and the holder is to renew the synthetic biometric credential). The issuer device 302 may revoke the synthetic biometric credential if the issuer receives enough evidence of identity fraud. To help prevent against such fraud, biometric data may be protected by encryption and secure handling, and by not storing raw biometric data at the issuer device 302 or at verifier devices. Biometric data may not be stored in less secure locations, reducing the risk of data breaches, and holders may have more control over biometric data and may manage the synthetic biometric credential (self-sovereignty).

The decentralized nature of verifiable synthetic biometric credentials reduces the dependency on maintaining expensive centralized systems. Credentials can be verified with lightweight infrastructure, lowering overall operational costs. Verifiable synthetic biometric credentials can scale efficiently across different systems and regions, overcoming latency and accessibility challenges by decentralizing verification processes. Verifiable synthetic biometric credentials enable frictionless authentication by enabling users to reuse issued credentials without intrusive re-collection or additional steps. In case of loss or compromise, new credentials can be issued quickly and securely. The issuer device 302 may confirm identity consistency between the original and new synthetic biometric credentials.

The holder of the synthetic biometric credential may also have more self-sovereignty over biometric data. Verifiable synthetic biometric credentials decentralize data control, ensuring that no single authority can misuse or track user activity. Transparent, consent-based sharing minimizes risks of mission creep and unauthorized surveillance. Verifiable synthetic biometric credentials use globally recognized standards like DIDs and verifiable data registries, enabling seamless integration and cross-platform operability. Users are not locked into proprietary ecosystems, allowing flexibility in choosing verification providers.

FIG. 4 is a flowchart of an example process 400 associated with synthetic biometric credentials. In some implementations, one or more process blocks of FIG. 4 are performed by a device (e.g., computer 102).

As shown in FIG. 4, process 400 may include receiving a request for verification of an identity (block 410). For example, the device may receive a request for verification of an identity, as described above.

As further shown in FIG. 4, process 400 may include transmitting, in response to the request, a synthetic biometric credential stored in a digital wallet, where the synthetic biometric credential is a private-key encrypted or hashed representation of a biometric template associated with the identity (block 420). For example, the device may transmit a synthetic biometric credential stored in a digital wallet, where the synthetic biometric credential is a private-key encrypted or hashed representation of a biometric template associated with the identity, as described above.

Process 400 may include additional implementations, such as any single implementation or any combination of implementations described below and/or in connection with one or more other processes described elsewhere herein.

In a first implementation, process 400 includes receiving the synthetic biometric credential from an issuer, and storing the synthetic biometric credential in a digital wallet, where the digital wallet is a custom wallet or an integration with an existing wallet. In some implementations, process 400 includes storing synthetic biometric credentials in Hardware Security Modules (HSMs), in smartcards or secure elements in mobile phones, in Trusted Platform Modules (TPMs), or in other secure locations. Similarly, keys may be stored in hardware and retrieved for signing and verification. The hardware may perform the necessary cryptographic operations. In some implementations, certified hardware may help meet compliance requirements that involve handling sensitive data.

In a second implementation, alone or in combination with the first implementation, the synthetic biometric credential is verifiable using a public key obtained from a verifiable data registry.

In a third implementation, alone or in combination with one or more of the first and second implementations, the synthetic biometric credential reveals necessary information for verification and does not reveal the biometric template.

In a fourth implementation, alone or in combination with one or more of the first through third implementations, the receiving of the request includes obtaining an image of a QR code or receiving an NFC signal.

In a fifth implementation, alone or in combination with one or more of the first through fourth implementations, process 400 includes transmitting, to an issuer, a request to reissue the synthetic biometric credential, and receiving a reissued synthetic biometric credential that is based on a different algorithm or seed.

In a sixth implementation, alone or in combination with one or more of the first through fifth implementations, process 400 includes receiving a verification that the synthetic biometric credential has been verified by a data registry for synthetic biometric credentials, and performing one or more actions based on the verification.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

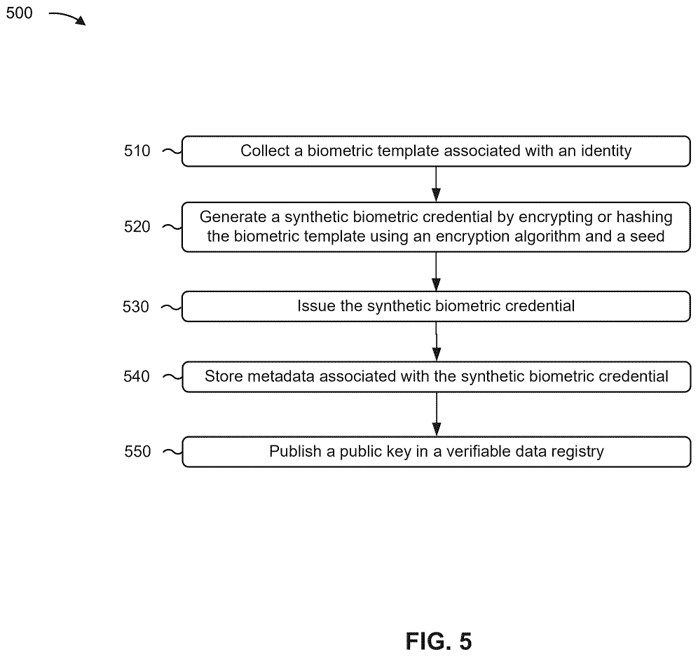

FIG. 5 is a flowchart of an example process 500 associated with synthetic biometric credentials. In some implementations, one or more process blocks of FIG. 5 are performed by a device (e.g., computer 102). In some implementations, one or more process blocks of FIG. 5 are performed by another device or a group of devices separate from or including the computer system.

As shown in FIG. 5, process 500 may include collecting a biometric template associated with an identity (block 510). For example, the device may collect a biometric template associated with an identity, as described above.

As further shown in FIG. 5, process 500 may include generating a synthetic biometric credential by encrypting or hashing the biometric template using an encryption algorithm and a seed (block 520). For example, the device may generate a synthetic biometric credential by encrypting or hashing the biometric template using an encryption algorithm and a seed, as described above.

As further shown in FIG. 5, process 500 may include issuing the synthetic biometric credential (block 530). For example, the device may issue the synthetic biometric credential, as described above.

As further shown in FIG. 5, process 500 may include storing metadata associated with the synthetic biometric credential (block 540). For example, the device may store metadata associated with the synthetic biometric credential, as described above.

As further shown in FIG. 5, process 500 may include publishing a public key in a verifiable data registry (block 550). For example, the device may publish a public key in a verifiable data registry, as described above.

Process 500 may include additional implementations, such as any single implementation or any combination of implementations described below and/or in connection with one or more other processes described elsewhere herein.

In a first implementation, process 500 comprises reissuing a new synthetic biometric credential based on a different algorithm or seed, and publishing a new public key associated with the new synthetic biometric credential in the verifiable data registry.

In a second implementation, alone or in combination with the first implementation, process 500 comprises managing a life cycle of the synthetic biometric credential.

In a third implementation, alone or in combination with one or more of the first and second implementations, process 500 comprises suspending or revoking the synthetic biometric credential.

In a fourth implementation, alone or in combination with one or more of the first through third implementations, process 500 comprises updating a status of the synthetic biometric credential.

In a fifth implementation, alone or in combination with one or more of the first through fourth implementations, process 500 comprises deleting the biometric template after issuance of the synthetic biometric credential.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

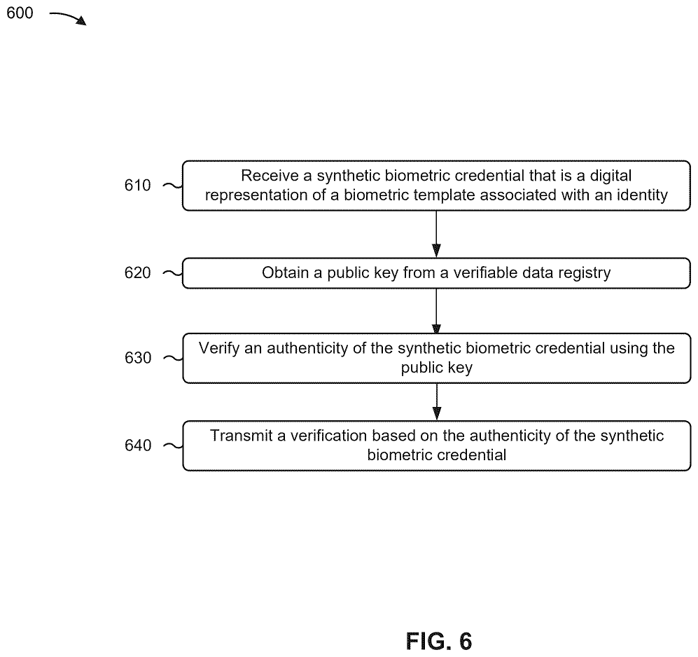

FIG. 6 is a flowchart of an example process 600 associated with synthetic biometric credentials. In some implementations, one or more process blocks of FIG. 6 are performed by a device (e.g., computer 102). In some implementations, one or more process blocks of FIG. 6 are performed by another device or a group of devices separate from or including the device.

As shown in FIG. 6, process 600 may include receiving a synthetic biometric credential that is a digital representation of a biometric template associated with an identity (block 610).

For example, the device may receive a synthetic biometric credential that is a digital representation of a biometric template associated with an identity, as described above.

As further shown in FIG. 6, process 600 may include obtaining a public key from a verifiable data registry (block 620). For example, the device may obtain a public key from a verifiable data registry, as described above.

As further shown in FIG. 6, process 600 may include verifying an authenticity of the synthetic biometric credential using the public key (block 630). For example, the device may verify an authenticity of the synthetic biometric credential using the public key, as described above.

As further shown in FIG. 6, process 600 may include transmitting a verification based on the authenticity of the synthetic biometric credential (block 640). For example, the device may transmit a verification based on the authenticity of the synthetic biometric credential, as described above.

Process 600 may include additional implementations, such as any single implementation or any combination of implementations described below and/or in connection with one or more other processes described elsewhere herein.

In a first implementation, the synthetic biometric credential is encrypted with a private key or hashed.

In a second implementation, alone or in combination with the first implementation, process 600 comprises requesting additional verification, where the additional verification is associated with a QR code or using an NFC signal.

In a third implementation, alone or in combination with one or more of the first and second implementations, process 600 comprises requesting revocation or suspension of the synthetic biometric credential.

In a fourth implementation, alone or in combination with one or more of the first through third implementations, process 600 comprises using a decentralized identifier for the verification.

In a fifth implementation, alone or in combination with one or more of the first through fourth implementations, process 600 comprises verifying the synthetic biometric credential without accessing raw biometric data or the biometric template.

In a sixth implementation, alone or in combination with one or more of the first through fifth implementations, process 600 comprises checking a status of the synthetic biometric credential in the verifiable data registry.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations or combinations to the precise forms disclosed.

Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method, comprising:
receiving, by a processor set and from an issuer device, a plurality of synthetic biometric credentials, wherein the plurality of synthetic biometric credentials are encrypted with a private key or are hashed representations of one or more biometric templates associated with an identity, and wherein the plurality of synthetic biometric credentials are signed by the issuer device using the private key;
receiving, by the processor set, a request for verification of an identity;
selecting, by the processor set, a subset of the plurality of synthetic biometric credentials based on the request; and
transmitting, by the processor set in response to the request, the subset of synthetic biometric credentials stored in a digital wallet.

2. The computer-implemented method of claim 1, further comprising:
storing the plurality of synthetic biometric credentials in the digital wallet, wherein the digital wallet is a custom wallet or an integration with an existing wallet.

3. The computer-implemented method of claim 1, wherein the plurality of synthetic biometric credentials are verifiable using a public key obtained from a verifiable data registry.

4. The computer-implemented method of claim 1, wherein the plurality of synthetic biometric credentials reveal necessary information for verification and do not reveal the one or more biometric templates.

5. The computer-implemented method of claim 1, wherein the receiving of the request includes obtaining an image of a quick response code or receiving a near-field communication signal.

6. The computer-implemented method of claim 1, further comprising:
transmitting, to the issuer device, a request to reissue a synthetic biometric credential of the plurality of synthetic biometric credentials; and
receiving a reissued synthetic biometric credential that is based on a different algorithm or seed.

7. The computer-implemented method of claim 1, further comprising:
receiving a verification that the subset of synthetic biometric credentials have been verified by a data registry for synthetic biometric credentials; and
performing one or more actions based on the verification.

8-20. (canceled)

21. A computer system, comprising:
a processor set;
one or more computer-readable storage media; and
program instructions stored on the one or more computer-readable storage media to cause the processor set to perform operations further comprising:
receiving, from an issuer device, a plurality of synthetic biometric credentials, wherein the plurality of synthetic biometric credentials are encrypted with a private key or are hashed representations of one or more biometric templates associated with an identity, and wherein the plurality of synthetic biometric credentials are signed by the issuer device using the private key;
receiving a request for verification of an identity;
selecting a subset of the plurality of synthetic biometric credentials based on the request; and
transmitting, in response to the request, the subset of synthetic biometric credentials stored in a digital wallet.

22. The computer system of claim 21, wherein the operations further comprise:
storing the plurality of synthetic biometric credentials in the digital wallet, wherein the digital wallet is a custom wallet or an integration with an existing wallet.

23. The computer system of claim 21, wherein the plurality of synthetic biometric credentials are verifiable using a public key obtained from a verifiable data registry.

24. The computer system of claim 21, wherein the plurality of synthetic biometric credentials reveal necessary information for verification and do not reveal the one or more biometric templates.

25. The computer system of claim 21, wherein the receiving of the request includes obtaining an image of a quick response code or receiving a near-field communication signal.

26. The computer system of claim 21, wherein the operations further comprise:
transmitting, to an issuer, a request to reissue a synthetic biometric credential of the plurality of synthetic biometric credentials; and
receiving a reissued synthetic biometric credential that is based on a different algorithm or seed.

27. The computer system of claim 21, wherein the operations further comprise:
receiving a verification that the subset of synthetic biometric credentials have been verified by a data registry for synthetic biometric credentials; and
performing one or more actions based on the verification.

28. A computer program product, comprising:
one or more computer-readable storage media; and
program instructions stored on the one or more computer-readable storage media to perform operations comprising:
receiving, from an issuer device, a plurality of synthetic biometric credentials, wherein the plurality of synthetic biometric credentials are encrypted with a private key or are hashed representations of one or more biometric templates associated with an identity, and wherein the plurality of synthetic biometric credentials are signed by the issuer device using the private key;
receiving a request for verification of an identity;
selecting a subset of the plurality of synthetic biometric credentials based on the request; and
transmitting, in response to the request, the subset of synthetic biometric credentials stored in a digital wallet.

29. The computer program product of claim 28, wherein the operations further comprise:
storing the plurality of synthetic biometric credentials in the digital wallet, wherein the digital wallet is a custom wallet or an integration with an existing wallet.

30. The computer program product of claim 28, wherein the plurality of synthetic biometric credentials are verifiable using a public key obtained from a verifiable data registry.

31. The computer program product of claim 28, wherein the plurality of synthetic biometric credentials reveal necessary information for verification and do not reveal the biometric template.

32. The computer program product of claim 28, wherein the receiving of the request includes obtaining an image of a quick response code or receiving a near-field communication signal.

33. The computer program product of claim 28, wherein the operations further comprise:
transmitting, to the issuer device, a request to reissue a synthetic biometric credential of the plurality of synthetic biometric credentials; and
receiving a reissued synthetic biometric credential that is based on a different algorithm or seed.
